(19) United States
(12) Patent Application Publication
(10) Pub. No.: US 2026/0273610 A1
(43) Pub. Date: Sep. 17, 2026

(54) CENTERING UNIT, CENTERING SYSTEM AND CENTERING METHOD FOR SHEETS AT LINE START OF STAMPING LINE

(71) Applicant: JIER MACHINE-TOOL GROUP CO.LTD, Jinan (CN)

(72) Inventors: Chuanying WANG, Jinan (CN); Bing ZHAO, Jinan (CN); Xiangyu WANG, Jinan (CN); Peng ZHANG, Jinan (CN); Teng ZHAO, Jinan (CN); Rongfeng WANG, Jinan (CN); Xipu CHEN, Jinan (CN)

(73) Assignee: JIER MACHINE-TOOL GROUP CO.LTD, Jinan (CN)

(21) Appl. No.: 19/676,713

(22) Filed: May 13, 2026

Related U.S. Application Data
(63) Continuation of application No. PCT/CN2025/126894, filed on Oct. 11, 2025.

(30) Foreign Application Priority Data
Oct. 14, 2024 (CN) 2024114274570

(51) Int. Cl. B21D 43/00; B21D 22/00; B23Q 15/24

(52) U.S. Cl. CPC B21D 43/003; B21D 22/00; B23Q 15/24

(57) ABSTRACT

The present invention relates to the field of stamping sheet centering. Provided are a centering unit, centering system and centering method for sheets at line start of a stamping line. The solution adopted is: each centering unit for sheets at line start of a stamping line includes a base, where a support frame is arranged on each base, a static platform is arranged on each support frame, three adjustment assemblies are arranged on each static platform, each adjustment assembly includes a moving seat, each moving seat can be linearly and movably arranged on the corresponding static platform, moving directions of the three moving seats enclose a triangular structure, a connecting end of a corresponding connecting rod is rotationally connected to each moving seat, adjustment ends of the three connecting rods are all rotationally connected to the same movable platform.

### CROSS-REFERENCE TO RELATED APPLICATIONS

The application claims priority to Chinese patent application No. 2024114274570, filed on Oct. 14, 2024, the entire contents of which are incorporated herein by reference.

### TECHNICAL FIELD

This disclosure relates to the field of stamping sheet centering, in particular to a centering unit, centering system and centering method for sheets at line start of a stamping line.

### BACKGROUND

Currently, many products in life (automotive components and other products) are manufactured through stamping of metal sheets. During a sheet stamping processing process, it is necessary to ensure the relative positional relationship between a die and sheets to avoid defects. However, during transportation, sheets at line start of a stamping line will deviate slightly from ideal positions, thus it is necessary to identify the deviation before centering.

In the prior art, the Chinese patent application with patent application publication No. CN115041602A discloses a centering belt conveyor for sheets through laser line scanning, including a bottom support, an integrated rotation unit, a translation unit, an independent rotation unit, a sheet conveying unit A and a sheet conveying unit B, where a slewing bearing a in the bottom support is connected to a slewing bearing seat a in the integrated rotation unit via screws, a translation rack in the translation unit is connected to a slider of a guide rail pair in the integrated rotation unit via bolts, a slewing bearing seat b in the independent rotation unit is connected to a slewing bearing b in the translation unit via bolts, and mounting supports in sheet conveying unit A and the sheet conveying unit B are connected to an independent rotation rack in the independent rotation unit via bolts. By adopting the technical solution, the two sheet conveying units can achieve synchronous conveying adjustment through the integrated rotation unit and the translation unit, thereby realizing centering adjustment of one sheet. The two sheet conveying units can also perform independent conveying adjustment, thereby achieving adjustment of two sheets.

However, by adopting the above technical solution, the integrated rotation unit, the translation unit and the independent rotation unit are provided layer by layer. Corresponding driving elements and corresponding transmission components are provided in each layer, which leads to a relatively large mass, and a complex overall structure, thus resulting in high manufacturing costs and high failure rates, and a cumbersome control process.

### SUMMARY

To solve the technical problem in the prior art of a too complex structure of a centering device for sheets at line start of a stamping line, provided in this disclosure are a centering unit, centering system and centering method for sheets at line start of a stamping line, the structure is simple, the overall volume and mass are small, and the control process is simple.

In a first aspect, to solve the above technical problem, provided in this disclosure are a centering unit for sheets at line start of a stamping line, each centering unit includes a base, where a support frame is provided on each base, a static platform is provided on each support frame, three adjustment assemblies are provided on each static platform, each adjustment assembly includes a moving seat, each moving seat can be linearly and movably arranged on the corresponding static platform, moving directions of the three moving seats enclose a triangular structure, a connecting end of a connecting rod is rotationally connected to each moving seat, adjustment ends of the three connecting rods are all rotationally connected to the same movable platform, each movable platforms and the corresponding static platform are arranged in parallel, and a conveying assembly is provided on each movable platform.

In this disclosure, by providing three adjustment assemblies capable of enclosing a triangle on each static platform, through coordinated cooperation of the three moving seats, rotation of the corresponding movable platform and position adjustment in the directions of length and width of the sheets are achieved. Compared with the prior art, this disclosure has the advantages that there is no need to provide a plurality of layers of platforms and a plurality of adjustment components to adjust the corresponding dimensions, respectively. Thus, the overall volume and weight are smaller, the structure is simple, there are few components, and control is easy, accurate and efficient.

Further, each adjustment assembly further includes a guide rail, the three guide rails are arranged on each static platform, straight lines where the three guide rails are located enclose a triangular structure, and each moving seat is movably arranged on the corresponding guide rail.

Further, each adjustment assembly further includes two support seats and a lead screw, where the two support seats are arranged at two ends of each guide rail, respectively, each lead screw passes through the corresponding two support seats, a driving electric motor is provided at one end of each lead screw, and each moving seat is arranged on the corresponding lead screw.

In this disclosure, the moving seats are driven by the lead screws and the electric motors to move, thereby achieving high precision in control and high accuracy in centering adjustment.

Further, a plurality of ball transfer units are provided on each static platform, and an upper end of each ball transfer unit abuts against the corresponding movable platform.

In this disclosure, by providing the plurality of ball transfer units, the loading capability for the movable platforms can be enhanced, thus avoiding complex and variable bearing load of the adjustment ends caused by adjustment only by the adjustment ends, to affect service life.

Further, each support frame includes a support sub-frame I and a support sub-frame II which are hinged, each support sub-frame I and the corresponding support sub-frame II are arranged in an X-shaped structure, a lower end of each support sub-frame is rotationally connected to the corresponding base, a lower end of each support sub-frame II is movably connected to the corresponding base, each support sub-frame II is further connected to a piston rod of a corresponding lifting cylinder, and each lifting cylinder is arranged on the corresponding base.

In this disclosure, by providing the support frames to be liftable, positions of the static platforms can be adjusted according to the thickness and the structure of the sheets, thus improving sheet conveying accuracy.

In a second aspect, further provided in this disclosure is a centering system for sheets at line start of a stamping line, including vision cameras and a controller which are electrically connected, and further including centering units for sheets at line start of a stamping line, where the vision cameras are arranged on a support and are arranged opposite the movable platforms, and the controller is electrically connected to the driving electric motors and the lifting cylinders.

Further, two centering units for sheets at line start of a stamping line are arranged, the two centering units for sheets at line start of a stamping line are arrayed in a direction perpendicular to a sheet conveying direction, and two vision cameras are arranged correspondingly.

In this disclosure, by providing the two centering units for sheets at line start of a stamping line, requirements for single-sheet feeding and dual-sheet feeding for the stamping line can be met, thereby enlarging the range of application of the system, and improving use flexibility.

In a third aspect, further provided in this disclosure is a centering method for sheets at line start of a stamping line, adopting the centering system for sheets at line start of a stamping line, and including the following steps:
S01: collecting image information of sheets to be fed, and transmitting the image information to the controller;
S02: determining, by the controller, single-sheet feeding or dual-sheet feeding according to the image information, if the single-sheet feeding is determined, calling a coordinate system for the single-sheet feeding, and if the dual-sheet feeding is determined, calling a coordinate system for the dual-sheet feeding;
S03: in the corresponding coordinate system, calculating, by the controller, the moving distance of each moving seat according to a position difference between actual coordinates and ideal coordinates of the sheets to be fed;
S04: moving the moving seats by a designated distance, to achieve centering adjustment for the sheets to be fed; and
S05: after conveying is completed, enabling the three moving seats to return to original positions for next feeding.

In this disclosure, by establishing different coordinate systems for the single-sheet feeding and the dual-sheet feeding, independent adjustment and coordinate adjustment of the two movable platforms can be achieved, and centering adjustment requirements for the single-sheet feeding and the dual-sheet feeding are met, thereby enlarging the range of application of the centering method, and improving the flexibility.

Further, in S02, the coordinate system for the single-sheet feeding includes a collaborative static coordinate system and a collaborative dynamic coordinate system, the origin of the collaborative static coordinate system is a middle point of center connecting lines of a triangle formed by three adjustment assemblies on each of two static platforms, an X-axis of the collaborative static coordinate system is a straight line where the moving direction of the moving seat of one adjustment assembly is located, a Y-axis of the collaborative static coordinate system is a straight line perpendicular to the moving direction of the moving seat, a Z-axis of the collaborative static coordinate system is a straight line perpendicular to the static platforms, the origin of the collaborative dynamic coordinate system is a middle point of centroid connecting lines of a triangle formed by three adjustment assemblies on each of two movable platforms, an X-axis of the collaborative dynamic coordinate system is a straight line where connecting lines of adjustment ends of connecting rods of the other two adjustment assemblies are located, and a Z-axis of the collaborative dynamic coordinate system is a straight line perpendicular to the movable platform; and the coordinate system for the dual-sheet feeding includes two independent static coordinate systems and two independent dynamic coordinate systems, origins of the two independent static coordinate systems are the center of a triangle formed by the three adjustment assemblies on the corresponding static platform, respectively, X-axes, Y-axes and Z-axes of the two independent static coordinate systems are all parallel to corresponding coordinate axes of the collaborative static coordinate system, origins of the two independent dynamic coordinate systems are the center of a triangle formed by the three adjustment ends on the corresponding movable platform, and X-axes, Y-axes and Z-axes of the two independent dynamic coordinate systems are all parallel to corresponding coordinate axes of the collaborative dynamic coordinate system.

Further, during the dual-sheet feeding, in S03, the following steps are executed:
S031: collecting image information of each sheet through the vision cameras, scanning a specific position and posture of each sheet, and converting position information of each sheet into digital coordinates under a vision camera coordinate system;
S032: performing communications through TCP/IP, and transmitting the information to the controller;
S033: performing, by the controller, end trajectory planning according to fed-back signals and pose transformation between the vision camera coordinate system and the independent static coordinate system, and according to the planned end pose point list, through an inverse kinematics solution of a single machine, calculating the required moving distance of each moving seat of the centering units for sheets at line start of a stamping line corresponding to each sheet;
during the single-sheet feeding, in S03, the following steps are executed:
S031: collecting image information of sheets through the vision cameras, scanning specific positions and postures of the sheets, and converting position information of the sheets into the digital coordinates under the vision camera coordinate system;
S032: performing communications through TCP/IP, and transmitting the information to the controller;
S033: performing, by the controller, trajectory planning according to fed-back signals and pose transformation between the vision camera coordinate system and the collaborative static coordinate system, and according to the planned end pose point list, through an inverse kinematics solution of dual machines, calculating the required moving distance of each moving seat.

As can be seen from the above technical solutions, this disclosure has the following advantages:
provided in this disclosure are a centering unit, centering system and centering method for sheets at line start of a stamping line, by providing the three adjustment assemblies capable of enclosing a triangle on each static platform, through coordinated cooperation of three moving seats, rotation of the movable platform and position adjustment in the directions of length and width of the sheets can be achieved. Compared with the prior art, this disclosure has the advantages that there is no need to provide a plurality of layers of platforms and a plurality of adjustment components to adjust the corresponding dimensions respectively. Therefore, the overall volume and the weight are smaller, the structure is simple with few components, and control is easy, accurate and efficient; the moving seats are driven by the lead screws and the electric motors to move, thereby achieving high precision in control and high accuracy in centering adjustment; by providing the plurality of ball transfer units, the loading capability for the movable platforms can enhanced, thus avoiding complex and variable bearing load of the adjustment ends caused by adjustment only by the adjustment ends, to affect service life; by providing the support frames to be liftable, positions of the static platforms can be adjusted according to the thickness and the structure of the sheets, thus improving sheet conveying accuracy; by providing the two centering units for sheets at line start of a stamping line, requirements for single-sheet feeding and dual-sheet feeding for the stamping line can be met, thereby enlarging the range of application of the system, and improving use flexibility; by establishing different coordinate systems for the single-sheet feeding and the dual-sheet feeding, independent adjustment and coordinate adjustment of the two movable platforms can be achieved, and centering adjustment requirements for the single-sheet feeding and the dual-sheet feeding can be met, thereby enlarging the range of application of the centering method, and improving the flexibility.

### BRIEF DESCRIPTION OF THE DRAWINGS

To describe the technical solutions of this disclosure more clearly, the following briefly introduces the accompanying drawings required for description. Apparently, the accompanying drawings in the following description show merely some embodiments of this disclosure, and those of ordinary skill in the art may still derive other accompanying drawings from these accompanying drawings without creative efforts.

FIG. 1 is a schematic structural diagram in a specific embodiment I of this disclosure.

FIG. 2 is a schematic diagram of an assembly structure of adjustment assemblies, movable platforms and static platforms in a specific embodiment I of this disclosure.

FIG. 3 is a schematic diagram of an assembly structure of adjustment assemblies and static platforms in a specific embodiment I of this disclosure.

FIG. 4 is a schematic structural diagram of adjustment assemblies in a specific embodiment I of this disclosure.

FIG. 5 is a schematic structural diagram of a specific embodiment II of this disclosure.

In figures, 1, static platform; 2, movable platform; 3, ball transfer unit; 4, driving electric motor; 5, vision camera; 6, support frame; 601, support sub-frame I; 602, support sub-frame II; 7, support; 8, conveying assembly; 10, base; 11, lifting cylinder; 12, connecting rod; 122, connecting end; 121, adjustment end; 13, lead screw; 14, moving seat; 15, guide rail; 16, support seat.

### DETAILED DESCRIPTION OF THE EMBODIMENTS

To make the objectives, features, and advantages of this disclosure more apparent and understandable, the following clearly and completely describes the technical solutions in this disclosure with reference to the accompanying drawings in specific embodiments of this disclosure. Apparently, the embodiments described below are some but not all of the embodiments of this disclosure. Based on the embodiments of this disclosure, all other embodiments obtained by those of ordinary skilled in the art without making creative labor fall within the scope of protection of this disclosure.

### Specific Embodiment I

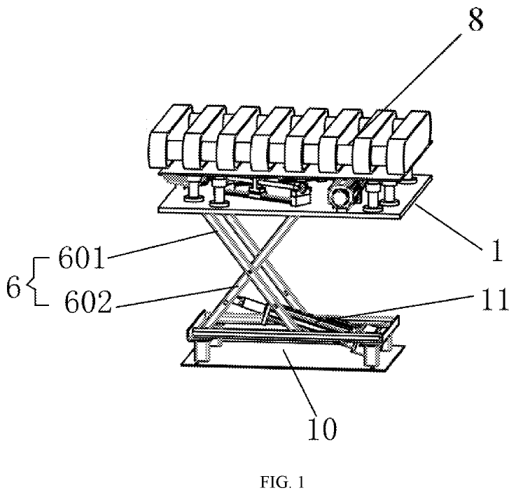

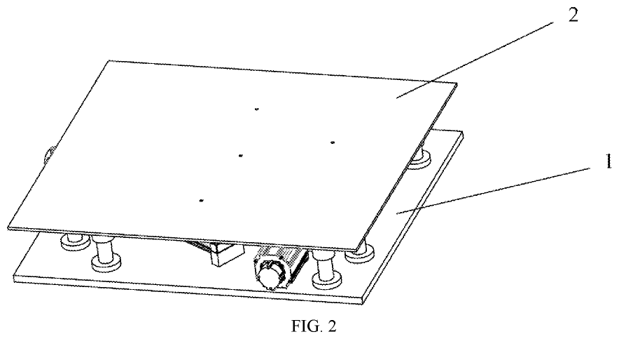

As shown in FIG. 1 to FIG. 3, provided in the specific embodiment is a centering unit for sheets at line start of a stamping line, each centering unit includes a base 10, a support frame 6, a movable platform 2, adjustment assemblies and a static platform 1, where each support frame 6 is provided on the corresponding base 10, each static platform 1 is provided on the corresponding support frame 6, three adjustment assemblies are provided on each static platform 1, each adjustment assembly includes a moving seat 14, each moving seat 14 can be linearly and movably arranged on the corresponding static platform 1, moving directions of the three moving seats 14 enclose a triangular structure, a connecting end 122 of a connecting rod 12 is rotationally connected to each moving seat 14 through a corresponding second rotating shaft, adjustment ends 121 of the three connecting rods 12 are all rotationally connected to the same movable platform 2 through the rotating shafts, each movable platform 2 and the corresponding static platform 1 are arranged in parallel, and a conveying assembly 8 is provided on each movable platform 2.

In the specific embodiment, by providing the three adjustment assemblies capable of enclosing a triangle on each static platform 1, through coordinated cooperation of three moving seats 14, rotation of the corresponding movable platform 2 and position adjustment in the directions of length and width of the sheets can be achieved. Compared with the prior art, this disclosure has the advantages that there is no need to provide a plurality of layers of platforms and a plurality of adjustment components to adjust the corresponding dimensions, respectively. Thus, the overall volume and weight are smaller, the structure is simple, there are few components, and control is easy, accurate and efficient.

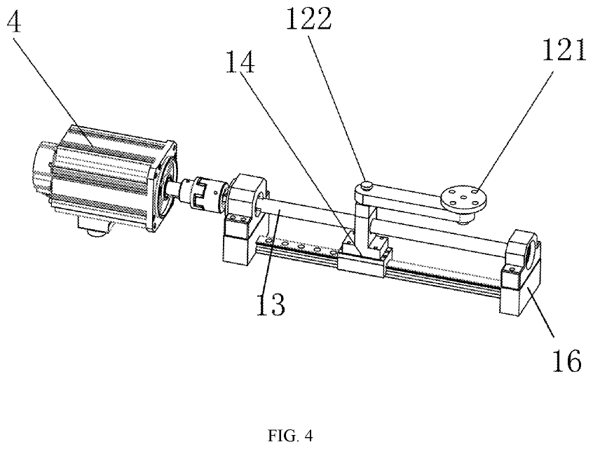

As shown in FIG. 4, in the specific embodiment, each adjustment assembly further includes a guide rail 15, three guide rails 15 are arranged on each static platform 1, straight lines where the three guide rails are located enclose a triangular structure, and each moving seat 14 is movably arranged on the corresponding guide rail 15; each adjustment assembly further includes two support seats 16 and a lead screw 13, where the two support seats 16 are arranged at two ends of each guide rail 15, respectively, each lead screw 13 passes through the corresponding two support seats 16, a driving electric motor 4 is provided at one end of each lead screw, and each moving seat 14 is arranged on the corresponding lead screw 13; and the moving seats 14 are driven by the lead screws 13 and the electric motors to move, thereby achieving high precision in control and high accuracy in centering adjustment.

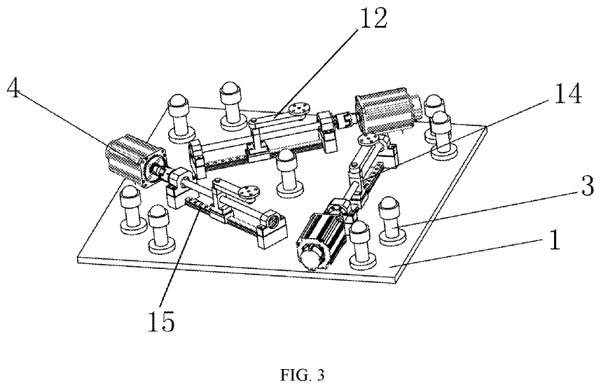

As shown in FIG. 3, the movable platforms 2 bear loads of a transmission assembly and sheets, a connecting rod 12 is rotationally provided at the lower part of each movable platform 2, to enhance support for the movable platforms 2 and avoid the connecting rods 12 from providing force for driving the movable platforms 2 to move and from bearing vertical load simultaneously, in the specific embodiment, a plurality of ball transfer units 3 are provided on each static platform 1, and the upper ends of the ball transfer units 3 abut against the movable platforms 2. In the specific embodiment, the ball transfer units 3 are arranged at the periphery and at the central position of the static platforms 1 in pair.

As shown in FIG. 1, because different sheets have different thicknesses and heights, to improve the application flexibility of the units, in the specific embodiment, each support frame 6 includes a support sub-frame I 601 and a support sub-frame II 602 which are hinged, each support sub-frame I 601 and the corresponding support sub-frame II 602 are arranged in an X-shaped structure, a lower end of each support sub-frame I 601 is rotationally connected to an accommodating slot in the corresponding base 10 through the corresponding rotating shaft, a lower end of each support sub-frame II 602 is movably connected to an accommodating slot in the corresponding base 10 through the corresponding guide rail, each support sub-frame II 602 is further rotationally connected to a piston rod of the corresponding lifting cylinder 11 through a corresponding pin shaft, and each lifting cylinder 11 is arranged in the accommodating slot in the corresponding base 10.

In the specific embodiment, the connecting end 122 of each connecting rod 12 is rotationally connected to the corresponding moving seat 14 through a rotating shaft and a corresponding bearing, the adjustment end 121 of each connecting rod 12 is rotationally connected to a corresponding support disc through a corresponding rotating shaft and a corresponding bearing, and each support disc is connected to the corresponding movable platform 2 via bolts.

### Specific Embodiment II

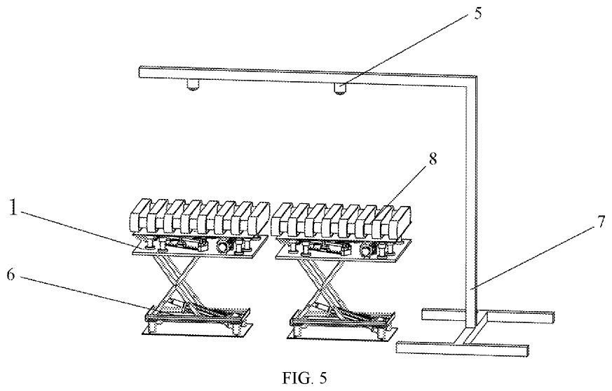

As shown in FIG. 5, further provided in the specific embodiment is a centering system for sheets at line start of a stamping line, including vision cameras 5 and a controller which are electrically connected, and further including centering units for sheets at line start of a stamping line according to the specific embodiment I, where the vision cameras 5 are arranged on a support 7 and are arranged opposite movable platforms 2, and the controller is electrically connected to driving electric motors 4 and lifting cylinders 11.

In the prior art, a stamping production line uses single-sheet feeding and dual-sheet feeding, to ensure that the system can meet centering adjustment requirements for single-sheet feeding and dual-sheet feeding, two centering units for sheets at line start of a stamping line are provided, the two centering units for sheets at line start of a stamping line are arrayed in a direction perpendicular to a sheet conveying direction, and the two vision cameras 5 are provided correspondingly.

In the specific embodiment, the controller includes a storage module and a calculation module, where the storage module stores a calculation method for the moving distances of the single-sheet feeding and the dual-sheet feeding, and the calculation module is used for performing calculation according to a selected calculation procedure.

### Specific Embodiment III

Further provided in the specific embodiment is a centering method for sheets at line start of a stamping line, adopting the centering system for sheets at line start of a stamping line according to specific embodiment II, and including the following steps:
S01: collecting, through vision cameras, image information of sheets to be fed, and transmitting the image information to a controller;
S02: determining, by the controller, single-sheet feeding or dual-sheet feeding according to the image information, if the single-sheet feeding is determined, calling a coordinate system for the single-sheet feeding, and if the dual-sheet feeding is determined, calling a coordinate system for the dual-sheet feeding;
S03: in a corresponding coordinate system, calculating, by the controller, a moving distance of each moving seat according to a position difference between actual coordinates and ideal coordinates of the sheets to be fed;
S04: moving the moving seats by a designated distance, to achieve centering adjustment for the sheets to be fed; and
S05: after conveying is completed, enabling the three moving seats to return to original positions for next feeding.

In the specific embodiment, by establishing different coordinate systems for the single-sheet feeding and the dual-sheet feeding, independent adjustment and coordinate adjustment of the two movable platforms can be achieved, and centering adjustment requirements for the single-sheet feeding and the dual-sheet feeding can be met, thereby enlarging the range of application of the centering method, and improving the flexibility.

In S02, the coordinate system for the single-sheet feeding includes a collaborative static coordinate system and a collaborative dynamic coordinate system, the origin of the collaborative static coordinate system is a middle point of center connecting lines of a triangle formed by three adjustment assemblies (three guide rails) on each of two static platforms, an X-axis of the collaborative static coordinate system is a straight line where the moving direction of the moving seat of one adjustment assembly is located, a Y-axis of the collaborative static coordinate system is a straight line perpendicular to the moving direction of the moving seat, a Z-axis of the collaborative static coordinate system is a straight line perpendicular to the static platforms, the origin of the collaborative dynamic coordinate system is a middle point of centroid connecting lines of a triangle formed by three adjustment assemblies on each of two movable platforms, an X-axis of the collaborative dynamic coordinate system is a straight line where connecting lines of adjustment ends of connecting rods of the other two adjustment assemblies are located, and a Z-axis of the collaborative dynamic coordinate system is a straight line perpendicular to the movable platform; and the coordinate system for the dual-sheet feeding includes two independent static coordinate systems and two independent dynamic coordinate systems, origins of the two independent static coordinate systems are the center of a triangle formed by the three adjustment assemblies on the corresponding static platform, respectively, X-axes, Y-axes and Z-axes of the two independent static coordinate systems are all parallel to corresponding coordinate axes of the collaborative static coordinate system, origins of the two independent dynamic coordinate systems are the center of a triangle formed by the three adjustment ends on the corresponding movable platform, and X-axes, Y-axes and Z-axes of the two independent dynamic coordinate systems are all parallel to corresponding coordinate axes of the collaborative dynamic coordinate system.

In S03, during the dual-sheet feeding, in S03, the following steps are executed:
S031: collecting image information of each sheet through the vision cameras, scanning a specific position and posture of each sheet, and converting position information of each sheet into digital coordinates under a vision camera coordinate system;
S032: performing communications through TCP/IP, and transmitting the information to the controller;
S033: performing, by the controller, end trajectory planning according to fed-back signals and pose transformation between the vision camera coordinate system and the independent static coordinate system, and according to the planned end pose point list, through an inverse kinematics solution of a single machine, calculating the required moving distance of each moving seat of the centering units for sheets at line start of a stamping line corresponding to each sheet;
during the single-sheet feeding, in S03, the following steps are executed:
S031: collecting image information of sheets through the vision cameras, scanning specific positions and postures of the sheets, and converting position information of the sheets into the digital coordinates under the vision camera coordinate system;
S032: performing communications through TCP/IP, and transmitting the information to the controller;
S033: performing, by the controller, trajectory planning according to fed-back signals and pose transformation between the vision camera coordinate system and the collaborative static coordinate system, and according to the planned end pose point list, through an inverse kinematics solution of dual machines, calculating the required moving distance of each moving seat.

Specifically, an inverse kinematics solution of dual machines for the single-sheet feeding is as follows:
the coordinate system for the single-sheet feeding includes a collaborative static coordinate system and a collaborative dynamic coordinate system, the origin of the collaborative static coordinate system O_{B}—X_{B}Y_{B}Z_{B} is a middle point of centroid connecting lines of a triangle formed by three adjustment assemblies on each of two static platforms, an X-axis of the collaborative static coordinate system is a straight line where the moving direction of the moving seat of one adjustment assembly is located, a Y-axis of the collaborative static coordinate system is a straight line perpendicular to the moving direction of the moving seat, a Z-axis of the collaborative static coordinate system is a straight line perpendicular to the static platforms, the origin of the collaborative dynamic coordinate system O_{A}—X_{A}Y_{A}Z_{A} is a middle point of centroid connecting lines of a triangle formed by three adjustment assemblies on each of two movable platforms, an X-axis of the collaborative dynamic coordinate system is a straight line where connecting lines of adjustment ends of connecting rods of the other two adjustment assemblies are located, and a Z-axis of the collaborative dynamic coordinate system is a straight line perpendicular to the movable platform.

The distance vector of the centers of the three adjustment assemblies of each static platform, relative to the origin O_{B} of the collaborative static coordinate system under the collaborative static coordinate system O_{B}—X_{B}Y_{B}Z_{B} is:

$${P}_{j} = {[ \begin{matrix}0 & {Y}_{Pj} & 0\end{matrix} ]}^{T} ( j = 1 , 2 ) ;$$

in the formula, j is the jth centering unit for sheets at line start of a stamping line, Y_{Pj} is a Y_{B}-direction distance of the origin (centroid of the triangle formed by the three adjustment assemblies on each static platform) of the static coordinate system of the jth centering unit for sheets at line start of a stamping line, relative to the origin O_{B} of the collaborative static coordinate system, under the collaborative static coordinate system O_{B}—X_{B}Y_{B}Z_{B}.

The offset vector of the origin O_{A} of the collaborative dynamic coordinate system relative to the origin O_{B} of the collaborative static coordinate system under the collaborative static coordinate system O_{B}—X_{B}Y_{B}Z_{B} is:

$$t = {[ \begin{matrix}Δ x & Δ y & Δ z\end{matrix} ]}^{T} ,$$

in the formula, Δx is a X_{B}-direction offset of the origin O_{A} of the collaborative dynamic coordinate system relative to the origin O_{B} of the collaborative static coordinate system under the collaborative static coordinate system O_{B}—X_{B}Y_{B}Z_{B}, Δy is a Y_{B}-direction offset of the origin O_{A} of the collaborative dynamic coordinate system relative to the origin O_{B} of the collaborative static coordinate system under the collaborative static coordinate system O_{B}—X_{B}Y_{B}Z_{B}, and Δz is a Z_{B}-direction offset of the origin O_{A} of the collaborative dynamic coordinate system relative to the origin O_{B} of the collaborative static coordinate system under the collaborative static coordinate system O_{B}—X_{B}Y_{B}Z_{B}.

If the torsion of the collaborative dynamic coordinate system O_{A}—X_{A}Y_{A}Z_{A} relative to the collaborative static coordinate system O_{B}—X_{B}Y_{B}Z_{B} is only Z_{A}-axis torsion, a rotation matrix of the collaborative dynamic coordinate system O_{A}—X_{A}Y_{A}Z_{A} relative to the collaborative static coordinate system O_{B}—X_{B}Y_{B}Z_{B} is:

$$T = [ \begin{matrix}c & - s & 0 \\ s & c & 0 \\ 0 & 0 & 1\end{matrix} ] ,$$

in the formula,

$$\{ \begin{matrix}c = cos θ \\ s = sin θ\end{matrix} ( θ is {Z}_{A} - axis torsion angle ) .$$

By taking the centroid of the triangle formed by the three adjustment ends on each movable platform as the origin, respective dynamic coordinate systems of the two units are established according to a right-hand triangle rule, under the respective dynamic coordinate systems, a position vector of an adjustment end 121 relative to the origins of the respective dynamic coordinate systems is:

$${R}_{i}^{′} = {[ \begin{matrix}{X}_{i} & {Y}_{i} & 0\end{matrix} ]}^{T} ( i = 1 , 2 , 3 , 4 , 5 , 6 ) ,$$

in the formula, i=1, 2, 3 corresponds to the three adjustment assemblies of a first centering unit for sheets at line start of a stamping line, i=4, 5, 6 corresponds to the three adjustment assemblies of the second centering unit for sheets at line start of a stamping line, Xᵢ is a X_{A}-direction distance of the adjustment end of the ith adjustment assembly relative to the origins of the respective dynamic coordinate systems under the respective dynamic coordinate systems, and Yᵢ is a Y_{A}-direction distance of the adjustment end of the ith adjustment assembly relative to the origins of respective dynamic coordinate systems under the respective dynamic coordinate systems.

The position vector of each adjustment end relative to the origin O_{B} of the collaborative static coordinate system under the collaborative static coordinate system

$${O}_{B} - {X}_{B} {Y}_{B} {Z}_{B} is :$$

$${R}_{i} = [ T ] {R}_{i}^{′} + t + {P}_{j} = [ \begin{matrix}{cX}_{i} - {sY}_{i} + Δ x \\ {sX}_{i} + {cY}_{i} + Δ y + {Y}_{Pj} \\ Δ z\end{matrix} ] ,$$

in the formula, if i=1, 2, 3, j=1; and if i=4, 5, 6, j=2.

By taking the centroid of the triangle formed by the three adjustment ends on each static platform as the origin, respective static coordinate systems of the two units are established according to the right-hand triangle rule, under the respective static coordinate systems, a position vector of the starting point of each adjustment assembly relative to the origins of the respective independent static coordinate systems under the respective independent static coordinate systems is:

$${Q}_{i} = {[ {X}_{q i} {Y}_{q i} 0 ]}^{T} ( i = 1 , 2 , 3 , 4 , 5 , 6 ) ,$$

in the formula, X_{qi} is a X_{B}-direction distance of the starting point (the starting point of the corresponding lead screw) of the ith adjustment assembly relative to the origins of the respective independent static coordinate systems under the respective independent static coordinate systems, and Y_{qi} is a Y_{B}-direction distance of the starting point of the ith adjustment assembly relative to the origins of the respective independent static coordinate systems under the respective independent static coordinate systems.

A motion distance vector of the moving seat of each adjustment assembly is:

$${l}_{i} = {[ {X}_{l i} {Y}_{l i} 0 ]}^{T} ( i = 1 , 2 , 3 , 4 , 5 , 6 ) ,$$

in the formula, Xₗᵢ is a X_{B}-direction distance of the center of the moving seat of the ith adjustment assembly relative to the starting point of the ith adjustment assembly under a generalized independent static coordinate system O_{B}—X_{B}Y_{B}Z_{B}, and Yₗᵢ is a Y_{B}-direction distance of the center of the moving seat of the ith adjustment assembly relative to the starting point of the ith adjustment assembly under the generalized independent static coordinate system O_{B}—X_{B}Y_{B}Z_{B}.

The coordinates of the moving seat of each adjustment assembly in vertical height is:

$$h = {[ 00 Δ z ]}^{T} ,$$

the position vector of the connecting end of each adjustment assembly relative to an axial line of the rotating shaft of the corresponding adjustment end under the collaborative static coordinate system O_{B}—X_{B}Y_{B}Z_{B} is:

$${l}_{z i} = {[ {X}_{z i} {Y}_{z i} 0 ]}^{T} ( i = 1 , 2 , 3 , 4 , 5 , 6 ) ,$$

in the formula, X_{zi} is a X_{B}-direction distance of the connecting end of each adjustment assembly relative to an axial line of the rotating shaft of the corresponding adjustment end under the collaborative static coordinate system O_{B}—X_{B}Y_{B}Z_{B}, and Y_{zi} is a Y_{B}-direction distance of the connecting end of each adjustment assembly relative to the axial line of the rotating shaft of the corresponding adjustment end under the collaborative static coordinate system O_{B}—X_{B}Y_{B}Z_{B}.

Then, the following closed-loop vector equation can be obtained:

$${P}_{j} + {Q}_{i} + {l}_{i} + h + {l}_{z i} = {R}_{i} ( j = 1 , 2 ) ( i = 1 , 2 , 3 , 4 , 5 , 6 ) ,$$

in the formula, if i=1, 2, 3, j=1; and if i=4, 5, 6, j=2.

Numerically, l_{zi} can be obtained by a geometric method, |l_{zi}| is denoted as the length of the rotating shaft, and by using (cXᵢ−sYᵢ+Δx, sXᵢ+cYᵢ+Δy) as the center of a circle, the length of the rotating shaft as a radius, and each adjustment assembly as a straight line equation, the point where the intersection of the circle and the straight line equation is closest to the movable platform that moves at a previous moment is the coordinate of the second rotating shaft at the corresponding adjustment end.

$$denoted as \{ \begin{matrix}{R}_{xi} = {cX}_{i} - {sY}_{i} + Δ x \\ {R}_{yi} = {sX}_{i} + {cY}_{i} + Δ y ( i = 1 , 2 , 3 , 4 , 5 , 6 ) \\ {R}_{zi} = Δ z\end{matrix} ,$$

in the formula, Rₓᵢ, R_{yi} and R_{zi} are a X_{B}-direction distance, a Y_{B}-direction distance and a Z_{B}-direction distance of the center of a circle relative to the origin O_{B} of the collaborative static coordinate system under the collaborative static coordinate system O_{B}—X_{B}Y_{B}Z_{B}.

An equation of the circle and the straight lines is:

$$\{ \begin{matrix}{( x - {R}_{x i} )}^{2} + {( y - {R}_{y i} )}^{2} = {\vert {l}_{z i} \vert}^{2} \\ y = {m}_{i} x + {n}_{i}\end{matrix} ( i = 1 , 2 , 3 , 4 , 5 , 6 ) ,$$

in the formula, mᵢ and nᵢ are both coefficients of the straight line equation.

The system of linear equations in two unknowns is solved to obtain:

$$\{ \begin{matrix}{x}_{1} = \frac{- {b}_{i} + \sqrt{{b}_{i} - 4 {a}_{i} {c}_{i}}}{2 {a}_{i}} \\ {y}_{1} = {m}_{i} {x}_{1} + {n}_{i}\end{matrix} ( i = 1 , 2 , 3 , 4 , 5 , 6 )$$

$$or$$

$$\{ \begin{matrix}{x}_{2} = \frac{- {b}_{i} - \sqrt{{b}_{i} - 4 {a}_{i} {c}_{i}}}{2 {a}_{i}} \\ {y}_{2} = {m}_{i} {x}_{1} + {n}_{i}\end{matrix} ( i = 1 , 2 , 3 , 4 , 5 , 6 ) ,$$

in the formula,

$$\{ \begin{matrix}{a}_{i} = 1 + {m}_{i}^{2} \\ {b}_{i} = 2 {m}_{i} ( {n}_{i} - {R}_{y i} ) - 2 {R}_{x i} \\ {c}_{i} = {R}_{x i}^{2} + {( {n}_{i} - {R}_{y i} )}^{2} - {l}_{z i}^{2}\end{matrix} ,$$

x₁ and y₁ are a first set of solutions to the system of linear equations, and x₂ and y₂ are a second set of solutions to the system of linear equations.

Assuming that (x₁, y₁) is the point where the intersection of the circle and the straight line equation is closest to the movable platform that moves at a previous moment, the position vector of each connecting end relative to the axial line of the rotating shaft of the corresponding adjustment end under the collaborative static coordinate system

$${O}_{B} - {X}_{B} {Y}_{B} {Z}_{B} is :$$

$${l}_{z i} = {[ {R}_{x i} - {x}_{1} {R}_{y i} - {y}_{1} 0 ]}^{T} ( i = 1 , 2 , 3 , 4 , 5 , 6 ) ,$$

$${P}_{j} + {Q}_{i} + {l}_{i} + {h}_{i} + {l}_{z i} = {R}_{i} ( j = 1 , 2 ) ( i = 1 , 2 , 3 , 4 , 5 , 6 ) is substituted ,$$

the motion distance vector of each moving seat can be solved;

$${l}_{i} = {[ \frac{- {b}_{i} + \sqrt{{b}_{i} - 4 {a}_{i} {c}_{i}}}{2 {a}_{i}} - {X}_{q i} {m}_{i} \frac{- {b}_{i} + \sqrt{{b}_{i} - 4 {a}_{i} {c}_{i}}}{2 {a}_{i}} + {n}_{i} - {Y}_{q i} 0 ]}^{T}$$

$$( i = 1 , 2 , 3 , 4 , 5 , 6 ) ,$$

thus, the moving distance of each moving seat is:

$$\vert {l}_{i} \vert = \sqrt{{( \frac{- {b}_{i} + \sqrt{{b}_{i} - 4 {a}_{i} {c}_{i}}}{2 {a}_{i}} - {X}_{q i} )}^{2} + {( {m}_{i} \frac{- {b}_{i} + \sqrt{{b}_{i} - 4 {a}_{i} {c}_{i}}}{2 {a}_{i}} + {n}_{i} - {Y}_{q i} )}^{2}}$$

$$( i = 1 , 2 , 3 , 4 , 5 , 6 ) ,$$

specifically, the inverse kinematics solution of a single machine for the dual-sheet feeding is as follows:

the coordinate system for the dual-sheet feeding includes two independent static coordinate systems and two independent dynamic coordinate systems, by taking one centering unit for sheets at line start of a stamping line as an example, the origin of each independent static coordinate system O_{DB}—X_{DB}Y_{DB}Z_{DB} is the centroid of a triangle formed by the three adjustment assemblies on the corresponding static platform, an X-axis, a Y-axis and a Z-axis of each independent static coordinate system are all parallel to corresponding coordinate axes of the collaborative static coordinate system, the origin of each independent dynamic coordinate system O_{DA}—X_{DA}Y_{DA}Z_{DA} is the centroid of a triangle formed by the three adjustment ends on the corresponding movable platform, and the X-axis, the Y-axis and the Z-axis of each independent dynamic coordinate system are all parallel to corresponding coordinate axes of the collaborative dynamic coordinate system.

The offset vector of the origin O_{DA} of each independent dynamic coordinate system relative to the origin O_{DB} of the corresponding independent static coordinate system under the independent static coordinate system O_{DB}—X_{DB}Y_{DB}Z_{DB} is:

$${t}_{D} = {[ Δ x Δ y Δ z ]}^{T} ,$$

in the formula, Δx is a X_{DB}-direction offset of the origin of each independent dynamic coordinate system ODA relative to the origin O_{DB} of the corresponding independent static coordinate system under the independent static coordinate system O_{DB}—X_{DB}Y_{DB}Z_{DB}, Δy is a Y_{DB}-direction offset of the origin O_{DA} of each independent dynamic coordinate system relative to the origin O_{DB} of the corresponding independent static coordinate system under the independent static coordinate system O_{DB}—X_{DB}Y_{DB}Z_{DB}, and Δz is a Z_{DB}-direction offset of the origin ODA of each independent dynamic coordinate system relative to the origin O_{DB} of the independent static coordinate system under the independent static coordinate system O_{DB}—X_{DB}Y_{DB}Z_{DB}.

If the torsion of each independent dynamic coordinate system O_{DA}—X_{DA}Y_{DA}Z_{DA} relative to the corresponding independent static coordinate system O_{DB}—X_{DB}Y_{DB}Z_{DB} is only ZDA-axis torsion, a rotation matrix of each independent dynamic coordinate system O_{DA}—X_{DA}Y_{DA}Z_{DA} relative to the corresponding independent static coordinate system O_{DB}—X_{DB}Y_{DB}Z_{DB} is:

$${T}_{D} = [ \begin{matrix}c & - s & 0 \\ s & c & 0 \\ 0 & 0 & 1\end{matrix} ] ,$$

in the formula,

$$\{ \begin{matrix}c = cos θ \\ s = sin θ\end{matrix} ( θ is {Z}_{D A} - axis torsion angle ) .$$

The position vector of each adjustment end relative to the origin O_{DA} of the corresponding independent dynamic coordinate system under the independent dynamic coordinate system O_{DA}—X_{DA}Y_{DA}Z_{DA} is:

$${R}_{D i}^{′} = {[ \begin{matrix}{X}_{Di} & {Y}_{Di} & 0\end{matrix} ]}^{T} ( i = 1 , 2 , 3 , 4 , 5 , 6 ) ,$$

in the formula, i=1, 2, 3 corresponds to the adjustment assemblies of the first centering unit for sheets at line start of a stamping line, i=4, 5, 6 corresponds to the adjustment assemblies of the second centering unit for sheets at line start of a stamping line, X_{Di} is a X_{DA}-direction distance of the adjustment end of the ith adjustment assembly relative to the origins O_{DA} of the independent dynamic coordinate systems under the independent dynamic coordinate systems O_{DA}—X_{DA}Y_{DA}Z_{DA}, and Y_{Di} is a Y_{DA}-direction distance of the adjustment end of the ith adjustment assembly relative to the origins O_{DA} of the independent dynamic coordinate systems under the independent dynamic coordinate systems O_{DA}—X_{DA}Y_{DA}Z_{DA}.

The position vector of each adjustment end relative to the origin O_{DB} of each independent static coordinate system under the corresponding independent static coordinate system O_{DB}—X_{DB}Y_{DB}Z_{DB} is:

$${R}_{D i} = [ {T}_{D} ] {R}_{D i}^{′} + {t}_{D} = [ \begin{matrix}{cX}_{Di} - {sY}_{Di} + Δ x \\ {sX}_{Di} + {cY}_{Di} + Δ y \\ Δ z\end{matrix} ] ,$$

the position vector of the starting point of each adjustment assembly relative to the origin O_{DB} of the corresponding independent static coordinate system under the independent static coordinate system O_{DB}—X_{DB}Y_{DB}Z_{DB} is:

$${Q}_{D i} = {[ \begin{matrix}{X}_{Dqi} & {Y}_{Dqi} & 0\end{matrix} ]}^{T} ( i = 1 , 2 , 3 , 4 , 5 , 6 ) ,$$

in the formula, X_{Dgi} is a X_{DB}-direction distance of the starting point of the ith adjustment assembly relative to the origin O_{DB} of the corresponding independent static coordinate system under the independent static coordinate system O_{DB}—X_{DB}Y_{DB}Z_{DB}, and Y_{Dqi} is a Y_{DB}-direction distance of the starting point of the ith adjustment assembly relative to the origin O_{DB} of the corresponding independent static coordinate system under the independent static coordinate system O_{DB}—X_{DB}Y_{DB}Z_{DB}.

A motion distance vector of the moving seat of each adjustment assembly is:

$${l}_{D i} = {[ \begin{matrix}{X}_{Dli} & {Y}_{Dli} & 0\end{matrix} ]}^{T} ( i = 1 , 2 , 3 , 4 , 5 , 6 ) ,$$

in the formula, X_{Dli} is a X_{DB}-direction distance of the center of the moving seat of the ith adjustment assembly relative to the starting point of the ith adjustment assembly under the independent static coordinate system O_{DB}—X_{DB}Y_{DB}Z_{DB}, and You is a Y_{DB}-direction distance of the center of the moving seat of the ith adjustment assembly relative to the starting point of the ith adjustment assembly under the independent static coordinate system O_{DB}—X_{DB}Y_{DB}Z_{DB}.

The coordinates of the moving seat of each adjustment assembly in vertical height is:

$${h}_{D} = {[ \begin{matrix}0 & 0 & Δ z\end{matrix} ]}^{T} ,$$

the position vector of the connecting end of each adjustment assembly relative to an axial line of the rotating shaft of the corresponding adjustment end under the independent static coordinate system O_{DB}—X_{DB}Y_{DB}Z_{DB} is:

$${l}_{Dzi} = {[ \begin{matrix}{X}_{Dzi} & {Y}_{Dzi} & 0\end{matrix} ]}^{T} ( i = 1 , 2 , 3 , 4 , 5 , 6 ) ,$$

in the formula, X_{Dzi} is a X_{DB}-direction distance of the connecting end of each adjustment assembly relative to an axial line of the rotating shaft of the corresponding adjustment end under the independent static coordinate system O_{DB}—X_{DB}Y_{DB}Z_{DB}, and Y_{Dzi} is a Y_{DB}-direction distance of the connecting end of each adjustment assembly relative to the axial line of the rotating shaft of the corresponding adjustment end under the independent static coordinate system O_{DB}—X_{DB}Y_{DB}Z_{DB}.

Then, the following closed-loop vector equation can be obtained:

$${Q}_{D i} + {l}_{D i} + {h}_{D} + {l}_{D z i} = {R}_{D i} ( i = 1 , 2 , 3 , 4 , 5 , 6 ) ,$$

numerically, l_{Dzi} can be obtained by the geometric method, |l_{Dzi}| is denoted as the length of the rotating shaft, and by using (cX_{Di}−sY_{Di}+Δx, sX_{Di}+cY_{Di}+Δy) as the center of a circle, the length of the rotating shaft as a radius, and each adjustment assembly as a straight line equation, the point where the intersection of the circle and the straight line equation is closest to the movable platform that moves at a previous moment is the coordinate of the second rotating shaft,

$$denoted as \{ \begin{matrix}{R}_{Dxi} = {cX}_{Di} - {sY}_{Di} + Δ x \\ {R}_{Dyi} = {sX}_{Di} + {cY}_{Di} + Δ y ( i = 1 , 2 , 3 , 4 , 5 , 6 ) , \\ {R}_{Dzi} = Δ z\end{matrix}$$

in the formula, R_{Dxi}, R_{Dyi} and R_{Dzi} are a X_{DB}-direction distance, a Y_{DB}-direction distance and a Z_{DB}-direction distance of the center of a circle relative to the origin O_{DB} of the independent static coordinate system under the independent static coordinate system O_{DB}—X_{DB}Y_{DB}Z_{DB}.

An equation of the circle and the straight lines is:

$$\{ \begin{matrix}{( x - {R}_{D x i} )}^{2} + {( y - {R}_{D y i} )}^{2} = {\vert {l}_{D z i} \vert}^{2} \\ y = {m}_{D i} x + {n}_{D i}\end{matrix} ( i = 1 , 2 , 3 , 4 , 5 , 6 ) ,$$

in the formula, m_{Di} and n_{Di} are both coefficients of the straight line equation.

The system of linear equations in two unknowns is solved to obtain:

$$\{ \begin{matrix}{x}_{1} = \frac{- {b}_{D i} + \sqrt{{b}_{D i} - 4 {a}_{D i} {c}_{D i}}}{2 {a}_{D i}} \\ {y}_{1} = {m}_{D i} {x}_{1} + {n}_{D i}\end{matrix} ( i = 1 , 2 , 3 , 4 , 5 , 6 )$$

$$or$$

$$\{ \begin{matrix}{x}_{2} = \frac{- {b}_{D i} - \sqrt{{b}_{D i} - 4 {a}_{D i} {c}_{D i}}}{2 {a}_{D i}} \\ {y}_{2} = {m}_{D i} {x}_{1} + {n}_{D i}\end{matrix} ( i = 1 , 2 , 3 , 4 , 5 , 6 ) ,$$

in the formula,

$$\{ \begin{matrix}{a}_{Di} = 1 + {m}_{D i}^{2} \\ {b}_{D i} = 2 {m}_{D i} ( {n}_{D i} - {R}_{D y i} ) - 2 {R}_{D x i} \\ {c}_{Di} = {R}_{Dxi}^{2} + {( {n}_{D i} - {R}_{D y i} )}^{2} - {l}_{D z i}^{2}\end{matrix} ,$$

x₁ and y₁ are a first set of solutions to the system of linear equations, and x₂ and y₂ are a second set of solutions to the system of linear equations.

Assuming that (x₁, y₁) is the point where the intersection of the circle and the straight line equation is closest to the movable platform that moves at a previous moment, the position vector of the connecting end of each adjustment assembly relative to the axial line of the rotating shaft of the corresponding adjustment end under the independent static coordinate system O_{DB}—X_{DB}Y_{DB}Z_{DB} is l_{Dzi}=[R_{Dxi}−x₁ R_{Dyi}−y₁ 0]^{T} (i=1, 2, 3, 4, 5, 6), after the Q_{Di}+l_{Di}+h_{Di}+l_{Dzi}=R_{Di} (i=1, 2, 3, 4, 5, 6) is substituted, the motion distance vector of the moving seat of each adjustment assembly can be solved:

$${l}_{D i} = {[ \begin{matrix}\frac{\begin{matrix}- {b}_{D i} + \\ \sqrt{{b}_{D i} - 4 {a}_{D i} {c}_{D i}}\end{matrix}}{2 {a}_{D i}} - {X}_{D q i} & {m}_{D i} \frac{\begin{matrix}- {b}_{D i} + \\ \sqrt{{b}_{D i} - 4 {a}_{D i} {c}_{D i}}\end{matrix}}{2 {a}_{D i}} + {n}_{D i} - {Y}_{D q i} & 0\end{matrix} ]}^{T}$$

$$( i = 1 , 2 , 3 , 4 , 5 , 6 ) ,$$

thus, the moving distance of the moving seat of each adjustment assembly is:

$$\vert {l}_{D i} \vert = \sqrt{\begin{matrix}{( \frac{- {b}_{D i} + \sqrt{{b}_{D i} - 4 {a}_{D i} {c}_{D i}}}{2 {a}_{D i}} - {X}_{D q i} )}^{2} + \\ {( {m}_{Di} \frac{- {b}_{D i} + \sqrt{{b}_{D i} - 4 {a}_{D i} {c}_{D i}}}{2 {a}_{D i}} + {n}_{Di} - {Y}_{Dqi} )}^{2}\end{matrix}} ( i = 1 , 2 , 3 , 4 , 5 , 6 ) ,$$

specifically, transformation between poses of the sheets under the independent static coordinate system or the collaborative static coordinate system and poses of the sheets under a vision camera coordinate system is as follows:
a homogeneous matrix of the poses of the sheets under the vision camera coordinate system is:

$${T}_{S} = [ \begin{matrix}cos ( {θ}_{S} ) & - sin ( {θ}_{S} ) & 0 & Δ {x}_{s} \\ sin ( {θ}_{S} ) & cos ( {θ}_{S} ) & 0 & Δ {y}_{s} \\ 0 & 0 & 1 & 0 \\ 0 & 0 & 0 & 1\end{matrix} ] ,$$

in the formula, Δxₛ, Δyₛ and θ_{S} are an X-direction offset, a Y-direction offset and a Z-direction offset angle of the poses of the sheets relative to a standard pose under the vision camera coordinate system.

If a transformation matrix of the independent static coordinate system or the collaborative static coordinate system and the vision camera coordinate system is T_{J}^{s}, the homogeneous matrix of the poses of the sheets of the independent static coordinate system or the collaborative static coordinate system is:

$${T}_{J} = {T}_{J}^{S} \times {T}_{S} [ \begin{matrix}cos ( θ ) & - sin ( θ ) & 0 & Δ x \\ sin ( θ ) & cos ( θ ) & 0 & Δ y \\ 0 & 0 & 1 & 0 \\ 0 & 0 & 0 & 1\end{matrix} ] ,$$

in the formula, Δx, Δy and θ are an X-direction offset, a Y-direction offset and a Z-direction offset angle of sheets relative to the standard pose under the independent static coordinate system or the collaborative static coordinate system.

As can be seen from the above specific embodiments, this disclosure has the following advantages:
1. By providing the three adjustment assemblies capable of enclosing a triangle on each static platform, through coordinated cooperation of three moving seats, rotation of the movable platform and position adjustment in the directions of length and width of the sheets can be achieved. Compared with the prior art, this disclosure has the advantages that there is no need to provide a plurality of layers of platforms and a plurality of adjustment components to adjust the corresponding dimensions respectively. Therefore, the overall volume and the weight are smaller, the structure is simple with few components, and control is easy, accurate and efficient;
2. The moving seats are driven by the lead screws and the electric motors to move, thereby achieving high precision in control and high accuracy in centering adjustment.
3. By providing the plurality of ball transfer units, the loading capability for the movable platforms can enhanced, thus avoiding complex and variable bearing load of the adjustment ends caused by adjustment only by the adjustment ends, to affect service life.
4. By providing the support frames to be liftable, positions of the static platforms can be adjusted according to the thickness and the structure of the sheets, thus improving sheet conveying accuracy.
5. By providing the two centering units for sheets at line start of a stamping line, requirements for single-sheet feeding and dual-sheet feeding for the stamping line can be met, range of application of the system is enlarged, and use flexibility is improved.
6. By establishing different coordinate systems for the single-sheet feeding and the dual-sheet feeding, independent adjustment and coordinate adjustment of the two movable platforms can be achieved, and centering adjustment requirements for the single-sheet feeding and the dual-sheet feeding can be met, thereby enlarging the range of application of the centering method, and improving the flexibility.

The above description of the disclosed embodiments enables those skilled in the art to implement or use this disclosure. Various modifications to these embodiments will be readily apparent to those skilled in the art, and the generic principles defined herein may be applied to other embodiments without departing from the spirit or scope of this disclosure. Thus, this disclosure is not intended to be limited to the embodiments shown herein but is to be in accordance with the widest scope consistent with the principles and novel features disclosed herein.

What is claimed is:

1. A centering unit for sheets at line start of a stamping line, comprising vision cameras (5) and a controller which are electrically connected, and further comprising centering units for sheets at line start of a stamping line, each centering unit for sheets at line start of a stamping line comprising a base (10), wherein a support frame (6) is provided on each base (10), a static platform (1) is provided on each support frame (6), three adjustment assemblies are provided on each static platform (1), each adjustment assembly comprises a moving seat (14), each moving seat (14) can be linearly and movably arranged on the corresponding static platform (1), moving directions of the three moving seats (14) enclose a triangular structure, a connecting end (122) of a connecting rod (12) is rotationally connected to each moving seat (14), adjustment ends (121) of the three connecting rods (12) are all rotationally connected to the same movable platform (2), each movable platform (2) and the corresponding static platform (1) are arranged in parallel, and a conveying assembly (8) is provided on each movable platform (2);
the vision cameras (5) are arranged on a support (7) and are arranged opposite the movable platforms (2), the controller comprises a storage module and a calculation module, the storage module stores a calculation method for a moving distance of the moving seats (14) corresponding to single-sheet feeding and dual-sheet feeding, and the calculation module is used for calculating the moving distance of the moving seats (14);
two centering units for sheets at line start of a stamping line are arranged, the two entering units for sheets at line start of a stamping line are arrayed in a direction perpendicular to a sheet conveying direction, and two vision cameras (5) are arranged;
the vision cameras (5) collect image information of sheets to be fed, and transmit the image information to the controller, the controller determines single-sheet feeding or dual-sheet feeding according to the image information, if the single-sheet feeding is determined, a coordinate system for the single-sheet feeding is called, and if the dual-sheet feeding is determined, a coordinate system for the dual-sheet feeding is called;
the coordinate system for single-sheet feeding comprises a collaborative static coordinate system and a collaborative movable coordinate system, wherein an origin of the collaborative static coordinate system is a midpoint of a connecting line of centroids of triangles formed by the three adjustment assemblies on each of the two static platforms, an X-axis of the collaborative static coordinate system is a straight line in the moving direction of the moving seat of one of the adjustment assemblies, a Y-axis of the collaborative static coordinate system is a straight line perpendicular to the moving direction of the moving seat, and a Z-axis of the collaborative static coordinate system is a straight line perpendicular to the static platform; an origin of the collaborative movable coordinate system is a midpoint of a connecting line of centroids of triangles formed by the three adjustment assemblies on each of the two movable platforms, an X-axis of the collaborative movable coordinate system is a straight line where a connecting line of adjustment ends of the connecting rods of the other two adjustment assemblies is located, and a Z-axis of the collaborative movable coordinate system is a straight line perpendicular to the movable platform; and the coordinate system for dual-sheet feeding comprises two independent static coordinate systems and two independent movable coordinate systems, wherein origins of the two independent static coordinate systems are respectively the centroids of the triangles formed by the three adjustment assemblies on the corresponding static platforms, the X-axis, the Y-axis, and the Z-axis of the two independent static coordinate systems are parallel to the corresponding axes of the collaborative static coordinate system, origins of the two independent movable coordinate systems respectively use the centroids of the triangles formed by the three adjustment ends of the movable platform as a coordinate origin, and the X-axis, the Y-axis, and the Z-axis of the two independent movable coordinate systems are parallel to the corresponding axes of the collaborative movable coordinate system.

2. The centering unit for sheets at line start of a stamping line according to claim 1, wherein each adjustment assembly further comprises a guide rail (15), the three guide rails (15) are arranged on each static platform (1), straight lines where the three guide rails are located enclose one triangular structure, and each moving seat (14) is movably arranged on the corresponding guide rail (15).

3. The centering unit for sheets at line start of a stamping line according to claim 2, wherein each adjustment assembly further comprises two support seats (16) and a lead screw (13), the two support seats (16) are arranged at two ends of each guide rail (15), respectively, each lead screw (13) passes through the corresponding two support seats (16), a driving electric motor (4) is provided at one end of each lead screw, and each moving seat (14) is arranged on the corresponding lead screw (13).

4. The centering unit for sheets at line start of a stamping line according to claim 3, wherein a plurality of ball transfer units (3) are provided on each static platform (1), and an upper end of each ball transfer unit (3) abuts against the corresponding movable platform (2).

5. The centering unit for sheets at line start of a stamping line according to claim 4, wherein the support frame (6) comprises a support sub-frame I (601) and a support sub-frame II (602) which are hinged, each support sub-frame I (601) and the corresponding support sub-frame II (602) are arranged in an X-shaped structure, a lower end of each support sub-frame I (601) is rotationally connected to the corresponding base (10), a lower end of each support sub-frame II (602) is movably connected to the corresponding base (10), each support sub-frame II (602) is further connected to a piston rod of a corresponding lifting cylinder (11), and each lifting cylinder (11) is arranged on the corresponding base (10).

6. A centering method for sheets at line start of a stamping line, adopting the centering system for sheets at line start of a stamping line according to claim 5, and comprising the following steps:
S01: collecting image information of sheets to be fed, and transmitting the image information to the controller;
S02: determining, by the controller, single-sheet feeding or dual-sheet feeding according to the image information, if the single-sheet feeding is determined, calling a coordinate system for the single-sheet feeding, and if the dual-sheet feeding is determined, calling a coordinate system for the dual-sheet feeding;
S03: in the corresponding coordinate system, calculating, by the controller, the moving distance of each moving seat according to a position difference between actual coordinates and ideal coordinates of the sheets to be fed;
S04: moving the moving seats by a designated distance, to achieve centering adjustment for the sheets to be fed; and
S05: after conveying is completed, enabling the three moving seats to return to original positions for next feeding.

7. The centering method for sheets at line start of a stamping line according to claim 6, wherein in S02, the coordinate system for the single-sheet feeding comprises a collaborative static coordinate system and a collaborative dynamic coordinate system, the origin of the collaborative static coordinate system is a middle point of centroid connecting lines of a triangle formed by three adjustment assemblies on each of two static platforms, an X-axis of the collaborative static coordinate system is a straight line where the moving direction of the moving seat of one adjustment assembly is located, a Y-axis of the collaborative static coordinate system is a straight line perpendicular to the moving direction of the moving seat, a Z-axis of the collaborative static coordinate system is a straight line perpendicular to the static platforms, the origin of the collaborative dynamic coordinate system is a middle point of centroid connecting lines of a triangle formed by three adjustment assemblies on each of two movable platforms, an X-axis of the collaborative dynamic coordinate system is a straight line where connecting lines of adjustment ends of connecting rods of the other two adjustment assemblies are located, and a Z-axis of the collaborative dynamic coordinate system is a straight line perpendicular to the movable platform; and the coordinate system for the dual-sheet feeding comprises two independent static coordinate systems and two independent dynamic coordinate systems, origins of the two independent static coordinate systems are the centroid of a triangle formed by the three adjustment assemblies on the corresponding static platform, respectively, X-axes, Y-axes and Z-axes of the two independent static coordinate systems are all parallel to corresponding coordinate axes of the collaborative static coordinate system, origins of the two independent dynamic coordinate systems are the centroid of a triangle formed by the three adjustment ends on the corresponding movable platform, and X-axes, Y-axes and Z-axes of the two independent dynamic coordinate systems are all parallel to corresponding coordinate axes of the collaborative dynamic coordinate system.

8. The centering method for sheets at line start of a stamping line according to claim 7, wherein during the dual-sheet feeding, in S03, the following steps are executed:
S031: collecting image information of each sheet through the vision cameras, scanning a specific position and posture of each sheet, and converting position information of each sheet into digital coordinates under a vision camera coordinate system;
S032: performing communications through TCP/IP, and transmitting the information to the controller;
S033: performing, by the controller, end trajectory planning according to fed-back signals and pose transformation between the vision camera coordinate system and the independent static coordinate system, and according to the planned end pose point list, through an inverse kinematics solution of a single machine, calculating the required moving distance of each moving seat of the centering units for sheets at line start of a stamping line corresponding to each sheet;
during the single-sheet feeding, in S03, the following steps are executed:
S031: collecting image information of sheets through the vision cameras, scanning specific positions and postures of the sheets, and converting position information of the sheets into the digital coordinates under the vision camera coordinate system;
S032: performing communications through TCP/IP, and transmitting the information to the controller;
S033: performing, by the controller, end trajectory planning according to fed-back signals and pose transformation between the vision camera coordinate system and the collaborative static coordinate system, and according to the planned end pose point list, through an inverse kinematics solution of dual machines, calculating the required moving distance of each moving seat.
